(19) United States
(12) Patent Application Publication
(10) Pub. No.: US 2019/0318520 A1
(43) Pub. Date: Oct. 17, 2019

(54) PROFILE-BASED IMAGE MODIFICATION

(71) Applicant: International Business Machines Corporation, Armonk, NY (US)

(72) Inventor: James Corvin FLETCHER, Apex, NC (US)

(21) Appl. No.: 15/955,268

(22) Filed: Apr. 17, 2018

(51) Int. Cl. G06T 11/60

(52) U.S. Cl. CPC G06T 11/60; H04L 67/2804

(57) ABSTRACT

Embodiments generally relate to modifying images. In some embodiments, a method includes accessing one or more images to be sent to at least one recipient. The method further includes accessing a profile, where the profile contains one or more rules for modifying images. The method further includes identifying content in the one or more images to be modified based on the one or more rules. The method further includes modifying the content in the one or more images based on the one or more rules, where the modifying of the content provides modified one or more images. The method further includes sending the modified one or more images to the at least one recipient.

### BACKGROUND

Removing content from images has long been performed manually, whether content is blacked out, faded, etc. Image editor products exist that edit images. The ability to selectively “hide” content of an image is limited, however, by the manual removal processes available in image editor products. These removal processes are manually performed on each image individually, which is time consuming, and error prone.

### SUMMARY

Disclosed herein is a method for modifying images, and a system and computer program product as specified in the independent claims. Embodiments are given in the dependent claims. Embodiments can be freely combined with each other if they are not mutually exclusive.

Embodiments automatically remove content from images based on profiles. Embodiments generally relate to modifying images. In some embodiments, a method includes accessing one or more images to be sent to at least one recipient. The method further includes accessing a profile, where the profile contains one or more rules for modifying images. The method further includes identifying content in the one or more images to be modified based on the one or more rules. The method further includes modifying the content in the one or more images based on the one or more rules, where the modifying of the content provides modified one or more images. The method further includes sending the modified one or more images to the at least one recipient.

In another aspect, the profile is associated with a sender of the one or more images. In another aspect, the content in the one or more images to be modified includes one or more objects, and where the modifying of the content in the one or more images includes modifying the one or more objects in the one or more images. In another aspect, the modifying of the content in the one or more images includes obscuring the content. In another aspect, the one or more rules include obscuring at least one object in the one or more images, and where the at least one object is associated with a person. In another aspect, the one or more rules include obscuring at least one object in the one or more images, and where the at least one object is associated with a location. In another aspect, the one or more rules include obscuring at least one object in the one or more images, and where the at least one object is associated with predetermined text.

### BRIEF DESCRIPTION OF THE DRAWINGS

FIG. 1 is an example environment for modifying images, according to some embodiments.

FIG. 2 is an example flow diagram for modifying images, according to some embodiments.

FIG. 3 shows an example image and an example modified image, according to some embodiments.

FIG. 4 is an example environment for modifying images, according to some embodiments.

FIG. 5 is a block diagram of an example computer system, which may be used for embodiments described herein.

### DETAILED DESCRIPTION

Embodiments described herein facilitate removal of content from images. Embodiments automatically determine what content in images to obscure based on a user-specified profile, and embodiment provide variability in what aspects of the image are to be obscured based on the profile. Embodiments provide protection of the identity of particular profile-designated individuals in an image (e.g., group picture, etc.). For example, the profile may indicate that the system may obscure the face of a particular user in the image sent to one or more recipients. In various embodiments, the content to obfuscate may be explicitly specified or the inverse may also be specified, which is to obfuscate all content except a specific aspect of the image.

In some embodiments a system accesses an image to be sent to at least one recipient. The system further accesses a profile, where the profile contains one or more rules for modifying images. The system identifies content in the image to be modified based on the one or more rules. The system modifies the content in the image based on the one or more rules, which results in one more modified images. The method may then send one or more of the modified images to the at least one recipient.

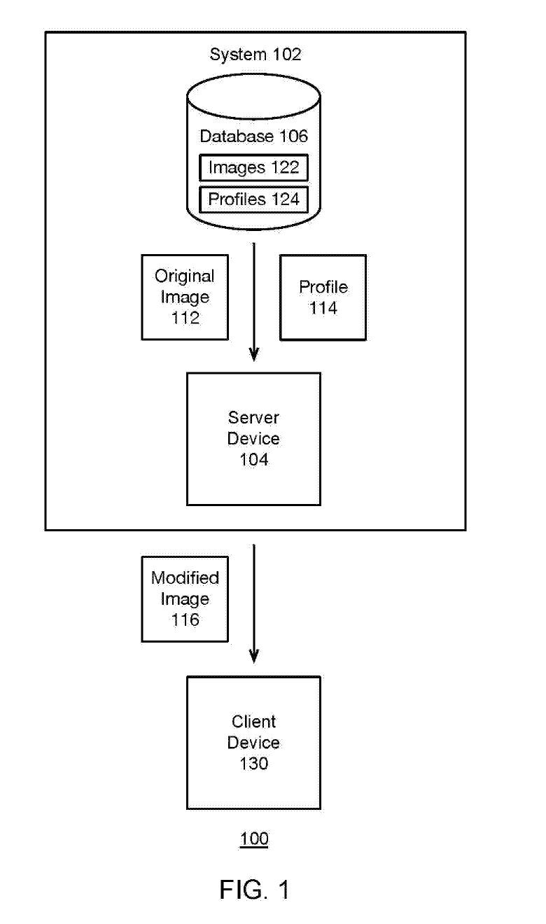

FIG. 1 is an example environment 100 for modifying images, according to some embodiments. Shown is a system 102 that includes a server device 104 and a database 106. As described in more detail herein, the server device 104 accesses an image 112 (labeled original image 112) and a profile 114. The profile 114 dynamically specifies the content to be modified (e.g., obscured) in the image 112.

In various embodiments, the server device 104 accesses the image 112 from a set of images 122 stored on the database 106, or other suitable storage location. The server device 104 also accesses the profile 114 from a set of profiles 124 stored on the database 106, or other suitable storage location.

The server device 104 modifies the image 112 to create one or more modified images such as modified image 116. The server device 104 may then store the modified image 116 on the database 106, or other suitable storage location, and send the modified image 116 to client devices of one or more users. For example, the server device 104 may send the modified image 116 to a client device 130.

For ease of illustration, FIG. 1 shows one block for each of the server device 104, the database 106, and client device 130. Blocks 104, 106, and 130 may represent multiple servers, databases, and client devices 130. In other implementations, environment 100 may not have all of the components shown and/or may have other elements including other types of elements instead of, or in addition to, those shown herein.

While the server device 104 performs embodiments described herein, in other embodiments, any suitable component or combination of components associated with the server device 104 or any suitable processor or processors associated with the server device 104 may facilitate performing the embodiments described herein.

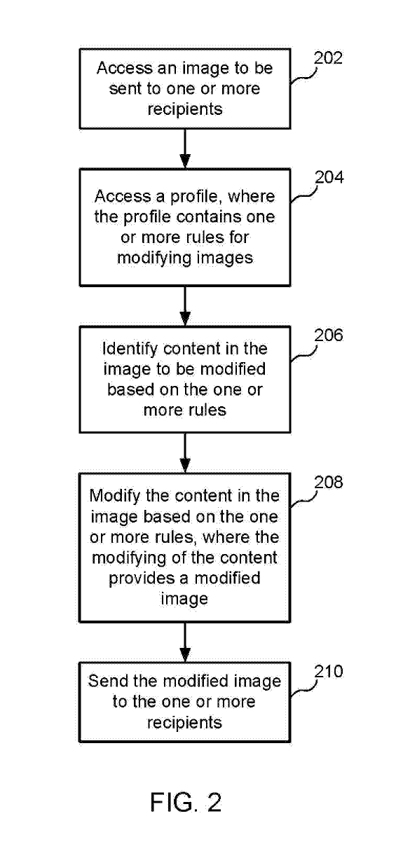

FIG. 2 is an example flow diagram for modifying images, according to some embodiments. Referring to both FIGS. 1 and 2, a method begins at block 202, where a system such as system 102 accesses one or more images (e.g., an image 112) to be sent to one or more recipients. In various embodiments, system 102 may access a series of images to be sent to one or more recipients. While some embodiments herein are described in the context of a single image (e.g., image 112), these embodiments and others apply to multiple images.

At block 204, the system 102 accesses a profile, where the profile 114 contains one or more rules for modifying images. As indicated herein, the profile 114 dynamically specifies the content to be modified (e.g., obscured) in the image 112.

For example, the profile 114 stores information on how to modify a particular image and/or group of images. For example, the profile 114 may indicate particular people or other objects in an image to obscure. Example rules for modifying images are described in more detail herein.

In various embodiments, the profile 114 is associated with a sender of the image. In an example scenario, the sender of the image 112 may be the person who took a photo containing the image using a camera. The profile 114 may be associated with that person. In various embodiments, the system 102 enables the person or user to specify particular individuals (e.g., the person child, etc.) to be obscured from the image when sent. The system 102 creates a modified image 116 to be sent in place of the original image 112.

At block 206, the system 102 identifies content in the image 112 to be modified based on the one or more rules. In various embodiments, the system 102 may use image recognition such as facial recognition to identify the content. In some embodiments, content identification may occur using several processes. For example, one can use global positioning system (GPS) metadata in an image to understand the location at which the image was taken. If the rules specify to obfuscate all indications of that location, those non-animate objects in the picture are removed. If the rule specifies a person, the rule may contain a person's image, which would be used to “image match” within the image to be pixelated. The matching image would be removed, or if inverse rules were used all other images except the person would be removed based on image matching. In some embodiments, the content to obfuscate may be explicitly specified or the inverse may also be specified, which is to obfuscate all content except a specific aspect of the image.

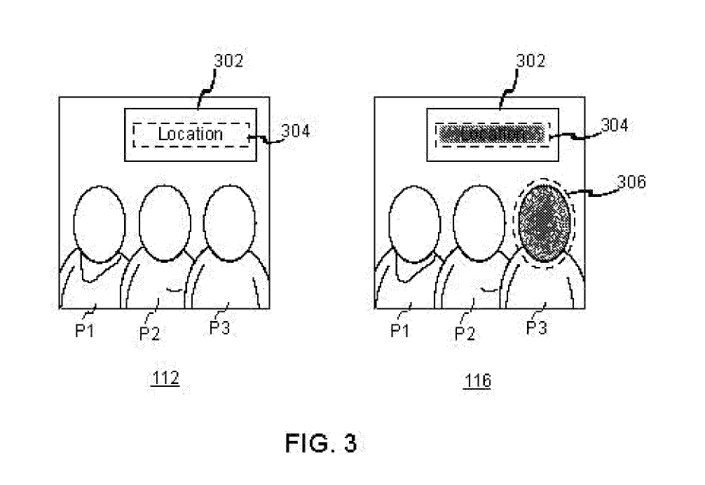

FIG. 3 shows the example image 112 and the example modified image 116 of FIG. 2, according to some embodiments. Shown in the image 112 are three people P1, P2, and P3 in a group photo, and a sign 302 that includes text 304 that indicates the location. In some embodiments, when identifying content in the image 112 to be modified, the system 102 identifies content (e.g., particular objects) to be obscured based on the one or more rules.

At block 208, the system 102 modifies the content in the image 112 based on the one or more rules, where the modifying of the content provides the modified images 116. As indicated herein, the content in the image to be modified includes one or more objects. For example, referring still to FIG. 3, objects P1, P2, and P3 show images three respective people, or people P1, P2, and P3, and an object 302 shows an image of a sign, or sign 302. In various embodiments, the modifying of the content in the image includes modifying one or more objects in the image.

In various embodiments, the modifying of the content in the image includes obscuring the content. For example, in this particular example scenario, the system 102 modifies the object or portion of the image (e.g., face 306) of the person P3 and modifies the object or portion of the image (e.g. text 304) of the sign 302. The system 102 may then store the modified image 116 in a suitable location such as database 106 of FIG. 1. The process is repeated for each identified aspect of the image.

At block 210, the system sends the modified image to the one or more recipients. After the desired content is removed, that content is not reproducible by the receiver of the image. In some embodiments, the system may also save the modified image to a storage device.

Each rule for modifying the image defines at least one action to be taken on one or more objects identified in the image. These rules manage the characteristics of the content of an image by controlling what objects or portions of an image are visible or not visible (e.g., obscured). For example, in various embodiments, the one or more rules include obscuring at least one object in the image. In various embodiments, the process can be either positive (e.g., obscure specified content) or negative (e.g., obscure all content except the specified content).

In some embodiments, at least one object to be obscured is associated with a person. For example, the profile may indicate that a specified person be obscured from one or more images. As such, in any given image, the object that represents the specified person will be obscured (e.g., the face 306 of person P3 of FIG. 3).

In some embodiments, at least one object to be obscured is associated with a location. For example, the profile may indicate that the system should obscure objects that help to recognize the location where the image was taken. As such, in any given image, the system will obscure any objects that indicate location.

In some embodiments, at least one object to be obscured is associated with predetermined text. For example, the profile may indicate that the system should obscure text that helps indicates the location where the image was taken. As such, in any given image, the system will obscure any text that indicates location (e.g., text 304 in the modified image 116 of FIG. 3).

In some embodiments, to obscure a particular object, the system may pixelate the object to be obscured in the image. The system may pixelate the specified object, where the system does not pixelate other objects. As a result, all objects in the image are visible except for the obscured object or objects (e.g., face 306 and text 304 in the modified image 116 of FIG. 3). In some embodiments, the rules may specify the level of pixilation to occur for any specific element of the image. For example, the system may enable the user to choose to remove any indication that the content removed was that of a person, or location by great obfuscation. The system may enable the user to choose to only obscure, but not remove complete content. In some embodiments, the level of obscurance may also be part of a rule.

Various techniques for obscuring an object in an image may vary, and the specific technique or techniques used will depend on the particular implementation. In some embodiments, to obscure a particular object, the system removes the object from the image. The system leaves the remaining objects intact. As a result, all objects in the image are visible except for the obscured object or objects. In some embodiments, the rules may specify the resultant blending for removed content. In some embodiments, the rules may remove content while blending the adjacent areas of the image to give the appearance that the content was not modified. Rules may specify the level of removal and blending desired.

While some embodiments are described herein in the context of images (e.g., photos), these embodiments and others may also apply to a series of images (e.g., videos).

Although the steps, operations, or computations may be presented in a specific order, the order may be changed in particular embodiments. Other orderings of the steps are possible, depending on the particular embodiment. In some particular embodiments, multiple steps shown as sequential in this specification may be performed at the same time. Also, some embodiments may not have all of the steps shown and/or may have other steps instead of, or in addition to, those shown herein.

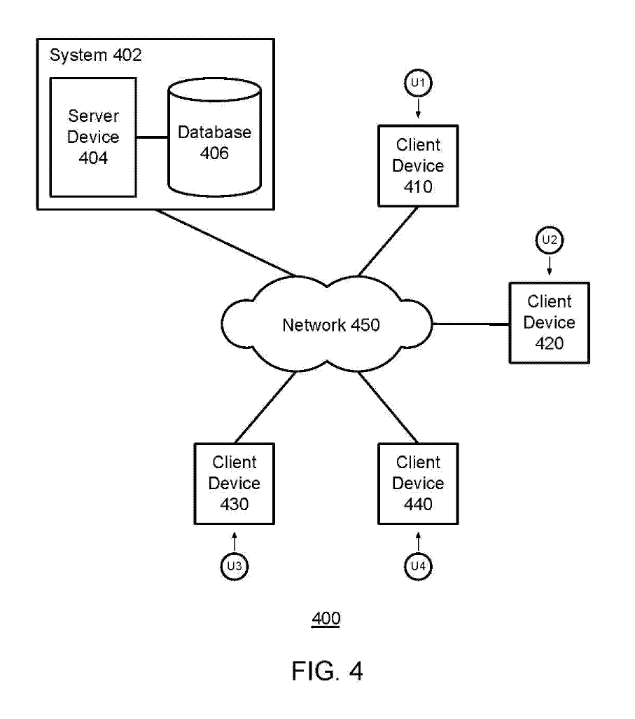

FIG. 4 is an example environment 400 for modifying images, according to some embodiments. Shown is a server 402, which includes a server device 404 and a database 406. The server device 402 may be used to implement the server device 104 of FIG. 1. The system 402 communicates with client devices 410, 420, 430, and 440 via a network 450. The network 450 may any suitable network such as the Internet, a local area network, a wide area network and/or a wireless network. In various implementations, users U1, U2, U3, and U4 may interact with each other or with system 402 using respective client devices 410, 420, 430, and 440.

For ease of illustration, FIG. 1 shows one block for each of the system 402, the server device 404, and the database 406. FIG. 1 also shows four blocks for the client devices 410, 420, 430, and 440. Blocks 402, 404, and 406 may represent multiple systems, server devices, and databases. Also, there may be any number of client devices. In other implementations, the environment 400 may not have all of the components shown and/or may have other elements including other types of elements instead of, or in addition to, those shown herein.

While the server 402 performs embodiments described herein, in other embodiments, any suitable component or combination of components associated with the server 402 or any suitable processor or processors associated with the server 402 may facilitate performing the embodiments described herein. In various embodiments, the environment 400 may not have all of the components shown and/or may have other elements including other types of components instead of, or in addition to, those shown herein.

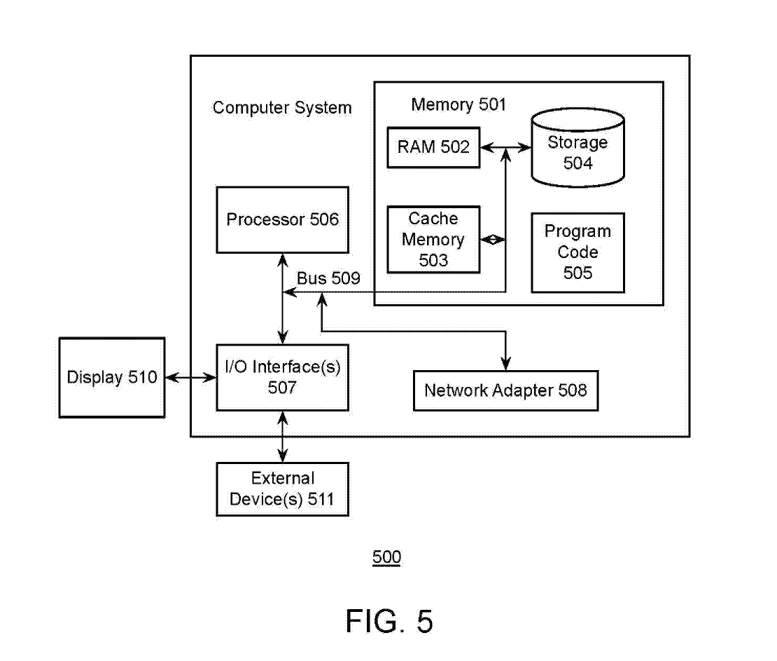

FIG. 5 is a block diagram of an example computer system 500, which may be used for embodiments described herein. The computer system 500 is operationally coupled to one or more processing units such as processor 506, a memory 501, and a bus 509 that couples various system components, including the memory 501 to the processor 506. The bus 509 represents one or more of any of several types of bus structure, including a memory bus or memory controller, a peripheral bus, an accelerated graphics port, and a processor or local bus using any of a variety of bus architectures. The memory 501 may include computer readable media in the form of volatile memory, such as random access memory (RAM) 502 or cache memory 503, or storage 504, which may include non-volatile storage media or other types of memory. The memory 501 may include at least one program product having a set of at least one program code module such as program code 505 that are configured to carry out the functions of embodiment of the present invention when executed by the processor 506. The computer system 500 may also communicate with a display 510 or one or more other external devices 511 via input/output (I/O) interfaces 507. The computer system 500 may communicate with one or more networks via network adapter 508.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
at least one processor and a computer readable storage medium having program instructions embodied therewith, the program instructions executable by the at least one processor to cause the at least one processor to perform operations comprising:
accessing one or more images to be sent to at least one recipient;
accessing a profile, wherein the profile contains one or more rules for modifying images;
identifying content in the one or more images to be modified based on the one or more rules;
modifying the content in the one or more images based on the one or more rules, wherein the modifying of the content provides modified one or more images; and
sending the modified one or more images to the at least one recipient.

2. The system of claim 1, wherein the profile is associated with a sender of the one or more images.

3. The system of claim 1, wherein the content in the one or more images to be modified comprises one or more objects, and wherein the modifying of the content in the one or more images comprises modifying the one or more objects in the one or more images.

4. The system of claim 1, wherein the modifying of the content in the one or more images comprises obscuring the content.

5. The system of claim 1, wherein the one or more rules comprises obscuring at least one object in the one or more images, and wherein the at least one object is associated with a person.

6. The system of claim 1, wherein the one or more rules comprises obscuring at least one object in the one or more images, and wherein the at least one object is associated with a location.

7. The system of claim 1, wherein the one or more rules comprises obscuring at least one object in the one or more images, and wherein the at least one object is associated with predetermined text.

8. A computer program product comprising a computer readable storage medium having program instructions embodied therewith, the program instructions executable by at least one processor to cause the at least one processor to perform operations comprising:
accessing one or more images to be sent to at least one recipient;
accessing a profile, wherein the profile contains one or more rules for modifying images;
identifying content in the one or more images to be modified based on the one or more rules;
modifying the content in the one or more images based on the one or more rules, wherein the modifying of the content provides modified one or more images; and
sending the modified one or more images to the at least one recipient.

9. The computer program product of claim 8, wherein the profile is associated with a sender of the one or more images.

10. The computer program product of claim 8, wherein the content in the one or more images to be modified comprises one or more objects, and wherein the modifying of the content in the one or more images comprises modifying the one or more objects in the one or more images.

11. The computer program product of claim 8, wherein the modifying of the content in the one or more images comprises obscuring the content.

12. The computer program product of claim 8, wherein the one or more rules comprises obscuring at least one object in the one or more images, and wherein the at least one object is associated with a person.

13. The computer program product of claim 8, wherein the one or more rules comprises obscuring at least one object in the one or more images, and wherein the at least one object is associated with a location.

14. The computer program product of claim 8, wherein the one or more rules comprises obscuring at least one object in the one or more images, and wherein the at least one object is associated with predetermined text.

15. A computer-implemented method for modifying images, the method comprising:
accessing one or more images to be sent to at least one recipient;
accessing a profile, wherein the profile contains one or more rules for modifying images;
identifying content in the one or more images to be modified based on the one or more rules;
modifying the content in the one or more images based on the one or more rules, wherein the modifying of the content provides modified one or more images; and
sending the modified one or more images to the at least one recipient.

16. The method of claim 15, wherein the profile is associated with a sender of the one or more images.

17. The method of claim 15, wherein the content in the one or more images to be modified comprises one or more objects, and wherein the modifying of the content in the one or more images comprises modifying the one or more objects in the one or more images.

18. The method of claim 15, wherein the modifying of the content in the one or more images comprises obscuring the content.

19. The method of claim 15, wherein the one or more rules comprises obscuring at least one object in the one or more images, and wherein the at least one object is associated with a person.

20. The method of claim 15, wherein the one or more rules comprises obscuring at least one object in the one or more images, and wherein the at least one object is associated with a location.
